(19) United States
(12) Patent Application Publication
(10) Pub. No.: US 2005/0178751 A1
(43) Pub. Date: Aug. 18, 2005

(54) Method and device for laser beam welding with reduced blemishes

(76) Inventors: Thomas Adelmann, Filderstadt (DE); Wolfgang Becker, Ulm (DE); Markus Beck, Oberelchingen (DE); Daniel Zauner, Ballendorf (DE)

Correspondence Address: PENDORF & CUTLIFF, 5111 Memorial Highway, Tampa, FL, 33634-7356, US

(21) Appl. No.: 10/996,774

(22) Filed: Nov. 24, 2004

(30) Foreign Application Priority Data
Nov. 25, 2003 (DE) 103 55 051.8-34

(51) Int. Cl. B23K 26/24

(52) U.S. Cl. 219/121.64; 219/121.61

(57) ABSTRACT

When laser beam welding two or more work pieces, the weld seam is usually visible on the work piece that is farthest from the laser beam, on the side of this work piece away from the laser beam. If this side is in an exposed area, then it must be reworked, which is expensive. The task of the present invention therefore consists of providing a method and a device for laser beam welding, with which a laser-welded seam can be formed without being so noticeable. The task is solved by determining the critical energy input per area unit and time unit into the work piece to be welded, above which an appearance of the welded seam to a degree exceeding a predetermined level will occur on the side away from the laser beam of the work piece that is farthest removed from the laser beam, and that the laser beam is controlled or regulated in such a way that the critical energy input per area unit and time unit is not exceeded.

### FIELD OF THE INVENTION

The invention concerns a method and a device for laser beam welding according to the precharcterizing portion of Patent Claims 1 and 5.

### BACKGROUND OF THE INVENTION

When laser beam welding two or more work pieces, the weld seam is usually visible on the work piece that is farthest from the laser beam, on the side of this work piece away from the laser beam. If this side is an exposed area, then, in many applications, especially in automobile construction, this has to be reworked, which is expensive. This applies in particular to work pieces which are to be painted, for example, the automobile body.

### SUMMARY OF THE INVENTION

The task of the present invention therefore consists of providing a method and a device for laser beam welding, with which a laser-welded seam can be formed without being so noticeable on the side of the work piece away from the laser beam.

The invention, with regard to providing a method for laser beam welding with reduced blemishing appearance, is set forth in the characterizing portion of Patent Claim 1, and with regard to the device according to the invention, is set forth in the characterizing portion of Patent Claim 5. The further claims define advantageous embodiments and further developments of the method according to the invention (Patent Claims 2 to 4).

The task, in regard to the method to be provided for laser beam welding with less noticeable appearance, is solved according to the invention by the fact that a critical energy input per area unit and time unit into the work piece to be welded is determined, above which a blemishing appearance of the welded seam to a degree exceeding a predetermined level will occur on the side away from the laser beam of the work piece that is farthest removed from the laser beam, and that the laser beam is controlled or regulated in such a way that the critical energy input per area unit and time unit is not exceeded.

Herein, the critical energy input per area unit and time unit can be determined directly, that is, in J/m²/s, or also indirectly in an equivalent form, that is, in a combination of suitable process parameters, until it is accomplished that no blemish occurs. Suitable process parameters are, for example, laser power, focusing (or laser beam diameter in the welding region) and speed of advancing the laser beam.

As soon as the critical energy input per area unit and time unit is determined, the laser beam can be controlled or regulated with the aid of known control or regulating units in such a way that there is no appearance of the laser beam welding seam on the back side of the work piece, or it appears only to a tolerable degree. The extent of tolerable blemish can be predetermined in a simple manner via an input device connected to the control or regulating device.

By predetermining a critical energy input per area unit and time unit, not only can the degree of blemish be regulated, but also the depth of the welded seam in the work piece facing away from the laser beam, usually called a back plate or sub-plate. Thus, especially in the case of thin sheets, any distortion can be minimized.

The minimization of blemish and distortion makes it possible, for example, to join flanges and cover plates more economically without expensive subsequent work on the welded seam. This is especially advantageous in bodywork construction.

### DETAILED DESCRIPTION OF THE INVENTION

In an advantageous embodiment of the method according to the invention, suitable control or regulating parameters are determined for the laser beam by simulation of the welding process and/or empirically before welding the work pieces and/or by measurement of emissions on the side away from the laser beam of the work piece farthest removed from the laser beam during welding, especially IR emission.

Suitable control or regulating parameters are, for example, the already mentioned laser power, focusing and laser beam advance speed. Suitable values of these parameters for providing a maximum tolerable or blemish free can be determined with the aid of known simulation methods in a simple manner. Alternatively, or in addition, they can also be determined empirically by processing sample work pieces at different values of the parameters in different ranges of values and then welding with these parameters and determining finally the extent of the blemish of the laser beam seam. Comparison of the blemishes provides a suitable set of parameters in a simple manner. Alternatively or in addition, the emission can be measured on the side away from the laser beam of the work piece farthest removed from the laser beam during the welding process and this can be compared with a critical value above which a blemish of the welded seam which exceeds a predetermined measure occurs. This critical emission value can again be determined by simulation or empirically.

The emission measurement is advantageously done in the infrared region (IR), since heating of the side away from the laser beam by the energy introduced by the laser beam can be measured significantly earlier than, for example, an alteration of this side of the work piece by optical measuring. Thus, the building up of the blemish can be recognized long before its development, recognized safely with the aid of its characteristic heating, that is, IR emission, and can be completely prevented by suitable control of the laser beam. Suitable IR sensors are known, for example, diodes or cameras, as well as fiber optic wave guides or video circuits, if necessary, for example, for reasons of space.

However, the emission measurement can also be performed in the optical region, since building up of a blemish is indicated ahead of time by discoloration of the surface. Such discolorations can also be recognized in time before the development of the blemish using suitable image recognition software and can be prevented completely by suitable control of the laser beam. The optical measurement has the advantage that it can be made available to an operator directly for process monitoring, while for a human operator the IR monitoring must first be converted into a suitable representation, for example, false color representation.

In an especially advantageous embodiment of the method according to the invention, suitable control or regulating parameters for the laser beam are determined locally and thus the laser beam is controlled or regulated in this way.

The advantage of this embodiment consists in the fact that, in this way, very different work piece thicknesses or deviations in geometry of the work piece and/or welded seam can be taken into consideration and, in spite of these local differences, a uniform seam quality can be achieved.

In another advantageous embodiment of the method according to the invention, the welded seam is made wider, especially by
superimposition of the feed movement of the laser beam with a local lateral movement component and/or
multiple laterally offset movements of the welded seam.

An especially suitable lateral beam movement runs in the form of a circular movement superimposed transversely on the seam as a broadening of the welded seam (so-called beam spinning). Thus, uniform coverage of a broadened seam region is provided, as a result of which a broadened bonding cross-section is obtained. Similarly, sinusoidal or zigzag seam shapes or a slight vibration of the guidance of the beam are suitable, which are preferably run through multiple times, slightly displaced, and thus produce a broadened bonding cross-section. The simplest broadening of the bonding cross-section is, however, achieved by several straight welded seams offset parallel to one another.

The broadened cross-section makes it possible to obtain high bonding stability of the welded work pieces, even when the welding depth is reduced.

The described process steps can run in principle on a conventional welding device which preferably includes a robot for guiding the beam for reasons of precision and speed.

However, the method according to the invention proves to be especially advantageous when the laser beam is deflected on the surface with a scanner device. A scanner device is an especially rapid and flexible beam deflection device, for example, a mirror system (consisting of at least one mirror, which can be pivoted in a controllable manner around one or more axis) or also of acousto-optic modulators.

The great advantage of this embodiment of the method according to the invention consists in the fact that the scanner device is moved at the same time relative to the surface of a sheet and thus the scanner device guides the laser beam, for example, for a short work period, sinusoidally over a first part of a first seam and then very rapidly deflects it to the beginning of a slightly parallel displaced second part of the sinusoidal seam and then very rapidly to a second corresponding multipart seam. As a result of this, both the devices for optical guidance of a second laser beam, as well as the time required for repositioning of the laser beam during which a robot-guided laser beam has to be turned off in the usual manner, are eliminated. Thus, very high utilization of the laser system is made possible. In contrast to this, in conventional systems laser beams with rigid lens systems are deflected above the work processing lines. In order to begin a new processing, the laser beam must be guided to its beginning and, for this purpose, and the lens system has to be moved relative to the component. During this, the laser beam must be turned off in order to avoid unintended removal or sublimation of coating from the component. Instead of this, the present embodiment of the invention requires only a fraction of the processing time in comparison to conventional systems.

The task with regard to the device to be provided according to the invention for laser beam welding with reduced blemish is solved in that a device is provided for measurement of the emissions on the side away from the laser beam of the work piece farthest removed from the laser beam, which device is connected to a device for controlling the laser beam.

This device according to the invention permits the control of welding with suitable control parameters, for example, laser power, focusing and speed of advance of the laser beam. For this purpose, emissions are measured on the side away from the laser beam of the work piece farthest removed from the laser beam during welding, and measurements are compared with a critical value above which a blemish of the welded seam exceeding a predetermined threshold occurs. This critical emission value can again be determined by simulation or empirically. Therefore, this device allows remaining within a maximum blemish or a predeterminable welding depth without any blemish.

Suitable devices for controlling and for emission measurements are known. For example, these include IR or optical sensors, especially diodes or CCDs. These can be arranged in direct line of sight or indirectly through IR or optical waveguides to determine the emission, depending on the accessibility of the observation points.

The device according to the invention is found to be especially rapid and thus advantageous in combination with a scanner device, which deflects the laser beam to the work sites.

The method according to the invention will be explained in more detail with the aid of practical examples.

In a first practical example, two sheets, made of standard steel ST 14, are arranged on top of one another. Each of the sheets has a thickness of approximately 1 mm. A scanner device is moved uniformly above them and deflects a laser beam which is emitted from a device for laser beam welding over the work surface. The scanner device consists of a two-axis pivotable computer-controlled mirror system.

Empirical measurements on sample sheets showed that, for these sheets, a critical energy input per area unit and time unit is not exceeded when the following control parameters are set for the welding process: Laser power about 1900 watt, laser beam feed speed about 3 m/min, focus on the surface to be welded with a focal diameter of approximately 0.7 mm. The focus is located on the surface to be welded when the scanner device has a distance of approximately 300 mm from the surface of the sheet. The setting of these control parameters results in that no visible blemish of the welded seam occurs on the side away from the laser beam of the sheet which is farthest removed from the laser beam.

The welding beam is broadened when the feed movement of the laser beam has a local lateral movement component superimposed on it in the form of a circular movement with a diameter of approximately 1 mm, called beam spinning. The spinning frequency is x Hz. This broadening of the welded seam to about a width of 1.7 mm provides sufficient binding stability in spite of reduced welding beam depth.

In a second practical example, two sheets made of high-strength steel ZSTE 340 are arranged on top of one another. The sheet which faces the beam has a thickness of approximately 1 mm and the sheet away from the beam has a thickness of approximately 0.5 mm.

Simulation calculations showed that, for these sheets, a critical energy input per area unit and time unit is not exceeded when the following control parameters are set for the welding process: laser power of approximately 1800 watt, feed speed of the laser beam approximately 4 m/min, focus on the surface to be welded with a focal diameter of approximately 0.7 mm.

The welded seam is broadened by circular beam spinning analogously to the first practical example. However, since the lower sheet is thinner in this case and therefore a smaller energy input is provided in a controlled manner, parallel to the first broadened seam, a second broadened seam is welded at a distance of 2 mm. This can be done rapidly and simply with the aid of the scanner device and provides, even for this very thin lower sheet, a double seam without blemish and with sufficiently stable bonding cross-sections.

In a third practical example, two sheets of standard steel ST 14 are aligned on top of one another. Each of the sheets has a thickness of approximately 1.2 mm.

The device for laser beam welding includes an additional device for measuring emissions, on the side away from the laser beam, of the sheet furthest from the laser beam, which device for measuring is connected with a device for controlling the laser beam. The device for measuring emissions includes an optical CCD camera, which is directed to the side away from the lower sheet away from the laser beam, that is, to the bottom side of the seam to be welded. The CCD camera is connected to a computer which examines discolorations of the images yielded by the CCD camera using a known image analysis method. Discoloration is a first sign for blemish appearance of the seam—that is, for reaching a critical energy input into the lower sheet. The computer also serves as a control device for the laser beam. As soon as a discoloration is recognized, the energy input per area unit and time unit is reduced. Here, this is done by immediate increase of the speed of advance the laser beam by 20 percent. After the laser beam has produced a welded seam length of approximately 1 mm, the feed speed is reduced again by about 10 percent. Alternatively or in addition, the operator of the computer can choose a different speed increase, welded seam length, and speed eduction through the input unit of the computer. Again, alternatively or in addition, the operator can also determine changes of the laser power when discolorations occur.

In a fourth embodiment, a 3D scanner device is used. In this case, the operator of the control device can also make changes in the laser focus diameter when discolorations occur. Here, it is always the distance of the scanner mirror from the work surface which is altered.

The method according to the invention and the device according to the invention were found in the practical examples described above to be especially suitable for laser welding of steel sheets in the automobile industry.

Especially, a significant reduction or even avoidance of blemishes and distortion—especially in the case of thin sheets—can be achieved. By using a scanner device, additionally significant advantages are obtained regarding processing time and accuracy.

The invention is not limited to the practical examples outlined above, but rather can be applied to others.

In spite of having the operator of the control or regulating device enter the suitable control or regulating parameters, a database can also be set up into which suitable values for regularly used types of material and thicknesses are already contained, so the operator merely has to choose one of these.

The method is also especially advantageous in the welding of coated sheets. Thus, namely a small welding depth can be predetermined for the lower sheet, which makes sufficiently stable bonding possible without damaging the coating on the side away from the laser beam beyond an acceptable degree. This reduces corrosion sites and avoids a subsequent process step for their removal.

However, the method according to the invention is suitable not only for the steel sheets usually used in automobile construction, but also for welding other metals and even plastics.

1. A method for the laser beam welding of at least two work pieces, wherein
a critical energy input per area unit and time unit into the work piece to be welded is determined, above which an appearance of the laser beam seam on the side away from the laser beam of the work piece farthest removed from the laser beam occurs to a degree exceeding a predetermined value, and
the laser beam is controlled or regulated in such a way that the critical energy input per area unit and time unit is not exceeded.

2. The method according to claim 1, wherein
the suitable control or regulating parameters for the laser beam are determined by
simulation of the welding process and/or
empirical means before the welding of the work piece and/or
measurement of emissions on the side away from the laser beam of the work piece farthest removed from the laser beam during welding, especially IR emission.

3. A method according to claim 2, wherein, suitable control or regulating parameters for the laser beam are determined locally.

4. The method according to claim 1, wherein
the welded seam is widened, especially by
superimposition of a local lateral movement component onto the direction of advance movement of the laser beam, and/or
multiple laterally displaced passage of the welding seam.

5. (canceled)

6. A device for laser beam welding of work pieces, comprising
a laser for welding work pieces,
a device for the measurement of the emissions on the side away from the laser beam of the work piece farthest removed from the laser beam, and
a device for controlling the laser beam, said device for controlling connected to said device for measurement.
